(19) United States
(12) Patent Application Publication
(10) Pub. No.: US 2014/0265559 A1
(43) Pub. Date: Sep. 18, 2014

(54) VEHICULAR HIGH POWER ELECTRICAL SYSTEM

(71) Applicant: Levant Power Corporation, Woburn, MA (US)

(72) Inventors: Jonathan R. Leehey, Wayland, MA (US); Vladimir Gorelik, Medford, MA (US); Zackary M. Anderson, Cambridge, MA (US); William G. Near, Boston, MA (US)

(21) Appl. No.: 14/212,431

(22) Filed: Mar. 14, 2014

Related U.S. Application Data
(60) Provisional application No. 61/815,251, filed on Apr. 23, 2013.
(60) Provisional application No. 61/789,600, filed on Mar. 15, 2013.

(51) Int. Cl. B60L 11/18

(52) U.S. Cl. CPC B60L 11/18; B60L 2210/10
USPC 307/10.1

(57) ABSTRACT

A vehicle electrical system can include a high-power electrical bus that is controlled independently of an electrical bus connected to the vehicle battery. The high-power electrical bus may be supplied at least partially by a power converter (e.g., a DC/DC converter) that draws power from the vehicle battery, and which can at least partially decouple the high-power electrical bus from the vehicle battery. High-power electrical loads, such as an active suspension system, for example, may be powered by the high-power electrical bus.

### CROSS-REFERENCE TO RELATED APPLICATIONS

This application claims priority under 35 U.S.C. 119(e) to U.S. provisional application Ser. No. 61/789,600, titled “ACTIVE SUSPENSION,” filed Mar. 15, 2013, and U.S. provisional application Ser. No. 61/815,251, titled “ACTIVE SUSPENSION,” filed Apr. 23, 2013, each of which is hereby incorporated by reference in its entirety.

### BACKGROUND

1. Field of Invention

The techniques described herein relate generally to vehicle electrical systems, and in particular to vehicle electrical systems having a plurality of electrical buses. Techniques are described for supplying one or more high-power loads, such as an active suspension system, for example, via a high-power electrical bus.

2. Discussion of the Related Art

Dual-voltage automotive electrical systems have been proposed that have a low power 14V bus connected to a standard vehicle battery and a high-power 42V or 48V bus.

Various types of active suspension systems for vehicles have been proposed. Such systems typically have hydraulic actuator pumps that run continuously, drawing a significant amount of power from the vehicle electrical system.

### SUMMARY

Some embodiments relate to an electrical system for a vehicle. The electrical system includes a power converter configured to convert a vehicle battery voltage at a first electrical bus into a second voltage at a second electrical bus. The second voltage is at least as high as the vehicle battery voltage. The electrical system also includes an energy storage apparatus coupled to the second electrical bus. At least one load is coupled to the second electrical bus. The power converter is configured to provide power from the first electrical bus to the at least one load and to limit a power drawn from the first electrical bus to no higher than a maximum power. When the at least one load draws more power than the maximum power, the at least one load at least partially draws power from the energy storage apparatus.

Some embodiments relate to an electrical system for a vehicle. The electrical system includes a power converter configured to convert a vehicle battery voltage at a first electrical bus into a second voltage at a second electrical bus. The second voltage is at least as high as the vehicle battery voltage. The power converter is configured to provide power from the first electrical bus to a load coupled to the second electrical bus, and to limit a power drawn from the first electrical bus to no higher than a maximum power based on an amount of energy drawn from the first electrical bus over a time interval.

Some embodiments relate to an electrical system for a vehicle. The electrical system includes a power converter configured to convert a vehicle battery voltage at a first electrical bus into a second voltage at a second electrical bus. The second voltage is at least as high as the vehicle battery voltage. The power converter is configured to receive a signal indicating a state of the vehicle. The state of the vehicle represents a measure of energy available from the first electrical bus. At least one load is coupled to the second electrical bus. The power converter is configured to provide power from the first electrical bus to the at least one load and to limit a power drawn from the first electrical bus based on the state of the vehicle.

Some embodiments relate to an electrical system for a vehicle. The electrical system includes a power converter configured to convert a vehicle battery voltage at a first electrical bus into a second voltage at a second electrical bus. The power converter is configured to allow the second voltage to vary in response to a power source and/or power sink coupled to the second electrical bus. The second voltage is allowed to fluctuate between a first threshold and a second threshold.

Some embodiments relate to an electrical system for an electric vehicle. The electrical system includes a first electrical bus that operates at a first voltage and drives a drive motor of the electric vehicle. The electrical system includes an energy storage apparatus coupled to the first electrical bus. The electrical system also includes a second electrical bus that operates at a second voltage lower than the first voltage. The electrical system also includes a power converter configured to transfer power between the first electrical bus and the second electrical bus. The electrical system further includes at least one electrical load connected to and controlled by an electronic controller. The at least one electrical load is powered from the second electrical bus. The at least one electrical load includes an active suspension actuator.

Some embodiments relate to an electrical system for a vehicle. The electrical system includes an electrical bus configured to deliver power to a plurality of connected loads. The electrical system also includes an energy storage apparatus coupled to the electrical bus. The energy storage apparatus has a state of charge. The energy storage apparatus is configured to deliver power to the plurality of connected loads. The electrical system also includes a power converter configured to provide power to the energy storage apparatus and regulate the state of charge of the energy storage apparatus. The electrical system further includes at least one device that obtains information regarding an expected future driving condition. The power converter regulates the state of charge of the energy storage apparatus based on the expected future driving condition.

Some embodiments relate to an electrical system for a vehicle. The electrical system includes a power converter configured to convert a vehicle battery voltage at a first electrical bus into a second voltage at a second electrical bus. The second voltage is at least as high as the vehicle battery voltage. The electrical system also includes an energy storage apparatus connected across the power converter. A first terminal of the energy storage apparatus is connected to the first electrical bus and a second terminal of the energy storage apparatus is connected to the second electrical bus. At least one load is coupled to the second electrical bus. The power converter is configured to provide power from the first electrical bus to the at least one load and to limit a net power drawn from the first electrical bus to no higher than a maximum power. Net power drawn from the first electrical bus comprises a combination of power through the power converter and the energy storage apparatus.

Some embodiments relate to electrical system for a vehicle in which a power converter is configured to convert a vehicle battery voltage at a first electrical bus into a second voltage at a second electrical bus. The electrical system includes at least one controller configured to control at least one load coupled to the second electrical bus. The at least one controller is configured to measure the second voltage and to determine a state of the vehicle based on the second voltage. The at least one controller is configured to control the at least one load based on the state of the vehicle.

Some embodiments relate to an electrical system for a vehicle in which a power converter is configured to convert a vehicle battery voltage at a first electrical bus into a second voltage at a second electrical bus. The electrical system includes at least one controller configured to control at least one active suspension actuator coupled to the second electrical bus. The at least one controller is configured to measure the second voltage and to determine a state of the vehicle based on the second voltage. The at least one controller is configured to control the at least one active suspension actuator based on the state of the vehicle.

Some embodiments relate to a method of operating at least one load of a vehicle. The vehicle has an electrical system in which a power converter is configured to convert a vehicle battery voltage at a first electrical bus into a second voltage at a second electrical bus. At least one load is coupled to the second electrical bus. The method includes measuring the second voltage, determining a state of the vehicle based on the second voltage and controlling the at least one load based on the state of the vehicle.

Some embodiments relate to a method, device (e.g., a controller), and/or computer readable storage medium having stored thereon instructions, which, when executed by a processor, perform any of the techniques described herein.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques described herein.

FIG. 1 shows a vehicle electrical system having two electrical buses, according to some embodiments.

FIG. 2 shows a vehicle electrical system having an energy storage apparatus connected to bus B, according to some embodiments.

FIG. 3 shows a vehicle electrical system having an energy storage apparatus connected to bus A, according to some embodiments.

FIG. 4 shows a vehicle electrical system having an energy storage apparatus connected to bus A and bus B, according to some embodiments.

FIG. 5 shows an exemplary plot of maximum power that may be provided based on an amount of energy drawn from the vehicle battery over a time period, according to some embodiments.

FIGS. 6A, 6B and 6C illustrate the current flow through the power converter and an energy storage apparatus, according to some embodiments.

FIG. 7 illustrates hysteretic control of the power converter, according to some embodiments.

FIGS. 8A, 8B, 8C, 8D, 8E and 8F illustrate exemplary power conversion and energy storage topologies, according to some embodiments.

FIGS. 9A, 9B, 9C, 9D, 9E, 9F, 9G, 9H, 9I, 9J, 9K, 9L, 9M and 9N illustrate further exemplary power conversion and energy storage topologies, according to some embodiments.

FIG. 10A illustrates an active suspension actuator and a corner controller, according to some embodiments.

FIG. 10B illustrates a vehicle electrical system having a plurality of loads (e.g., corner controllers and active suspension actuators) connected to bus B, according to some embodiments.

FIG. 11 illustrates exemplary operating ranges for bus B, according to some embodiments.

FIG. 12 is a block diagram of an illustrative computing device of a controller.

### DETAILED DESCRIPTION

In some embodiments, a vehicle electrical system may include a high-power electrical bus that is controlled independently of an electrical bus connected to the vehicle battery. The high-power electrical bus may be supplied at least partially by a power converter (e.g., a DC/DC converter) that draws power from the vehicle battery, and which can at least partially decouple the high-power electrical bus from the vehicle battery. High-power electrical loads, such as an active suspension system, for example, may be powered by the high-power electrical bus.

The techniques described herein relate to controlling the high-power electrical bus and one or more loads coupled thereto. The techniques described herein can facilitate quickly supplying significant power to high-power electrical loads, such as an active suspension system, for example, connected to the high-power electrical bus, a technique referred-to herein as supplying “on-demand energy.” In some embodiments, an energy storage apparatus is coupled to the high-power electrical bus to facilitate supplying on-demand energy. A significant amount of power may be provided to a load connected to the high-power electrical bus while limiting the amount of power drawn from the vehicle battery, thereby mitigating the effect on the remainder of the vehicle electrical system of providing on-demand energy.

In some embodiments, one or more regenerative systems, such a regenerative suspension system or regenerative braking system, for example, may be coupled to the high-power electrical bus and may supply power to the high-power electrical bus. In some embodiments, an active suspension system may be “energy-neutral” in the sense that over time the amount of energy generated while in performing regeneration may be substantially equal to the amount of power consumed when actively driving the active suspension actuator.

FIG. 1 shows a vehicle electrical system 1, according to some embodiments. As shown in FIG. 1, vehicle electrical system 1 has two electrical buses: bus A and bus B. Bus A and bus B may be at the same voltage or at different voltages. In some embodiments, bus A and bus B are DC buses supplying a DC voltage. Bus A may be connected to the positive terminal of a vehicle battery 2. The negative terminal of the vehicle battery 2 may be connected to “ground” (e.g., the vehicle chassis). In a typical vehicle electrical system, vehicle battery 2 (and bus A) has a nominal voltage of 12V. In some embodiments, bus B may be at a higher voltage than bus A (with reference to “ground”). In some embodiments, bus B may have a nominal voltage of 24V, 42V, or 48 V, by way of example. However, the techniques described herein are not limited in this respect, as bus A bus B may be at any suitable voltages. The voltages of busses A and B may vary during operation of the vehicle, as discussed further below. Vehicle battery 2 may provide power to one or more vehicle systems (not shown) connected to bus A, as in conventional automotive electrical systems.

Vehicle electrical system 1 includes a power converter 4 to transfer energy between bus A and bus B. Power converter 4 may be a switching power converter controlled by one or more switches. In some embodiments, power converter 4 may be a DC/DC converter. Power converter 4 may be unidirectional or bidirectional. If power converter 4 is unidirectional, it may be configured to provide power from bus A to bus B. If power converter 4 is bidirectional, it may be configured to provide power from bus B to bus A and from bus A to bus B. For example, as mentioned above, in some embodiments one or more loads on bus B may be regenerative, such as a regenerative suspension system or regenerative braking system. If power converter 4 is bidirectional, power from a regenerative system coupled to bus B may be provided from bus B to bus A via power converter 4, and may charge the vehicle battery 2. Power converter 4 may have any suitable power conversion topology, as the techniques described herein are not limited in this respect.

In some embodiments, a bidirectional power converter 4 allows energy to flow in both directions. The power transfer capability of power converter 4 may be the same or different for different directions of power flow. For example, in the case of a configuration comprising directionally opposed buck and boost converters, each converter may be sized to handle the same amount of power or a different amount of power. As an example in a 12V to 46V system with different power conversion capabilities in different directions, the continuous power conversion capability from 12V to 46V may be 1 kilowatt, while from 46V to 12V in the reverse direction the power conversion capability may only be 100 watts. Such asymmetrical sizing may save cost, complexity, and space. These factors are especially important in automotive applications. In some embodiments, the power converter 4 may be used as an energy buffer/power management system without raising or lowering the voltage, and the input and output voltages may be roughly equivalent (e.g., a 12V to 12V converter). In some embodiments the power converter 4 may be connected to a DC bus with a voltage that fluctuates, for example, between 24V and 60V or 300V and 450V (e.g., for an electric vehicle).

Vehicle electrical system 1 may include a controller 5 (e.g., an electronic controller) configured to control the manner in which power converter 4 performs power conversion. Electronic controller 5 may be any type of controller, and may include a control circuit and/or a processor that executes instructions. Controller 5 may control the direction and/or magnitude of power flow in power converter 4, as discussed further below. Controller 5 may be integrated with power converter 4 (e.g., on the same board) or separate from power converter 5. Another aspect of the techniques described herein is the ability for an external energy management control signal to regulate power. To do so, controller 5 may receive, via a communication network 7, information (e.g., a maximum power and/or current) and/or instructions that may be used by controller 5 to control power converter 4. The network 7 may be any suitable type of communication network. For example, in some embodiments the network 7 may be a wired or wireless communications bus that allows communications among different systems in the vehicle. If the information is provided to the controller 5 for via a wired connection, it may be provided via a wire or a communication bus (e.g., a CAN bus). In some embodiments, an external CAN bus signal from the vehicle is able to send commands to controller 5 in order to dynamically manage and change directional power limits in each direction, or to download voltage limits and charge curves. In some embodiments, controller 5 may be within the same module as power converter 4, and coupled to the power converter 4 via a wire and/or another type of communications bus.

As shown in FIG. 1, one or more vehicle systems may be connected to bus B. In some embodiments, bus B may be a high-power electrical bus. As mentioned above, a vehicle system connected to bus B may be a power source or a power sink (e.g., a load). Some vehicle systems may act as power sources at some times and power sinks at other times.

Non-limiting examples of vehicle systems that may be connected to bus B include a suspension system 8, a traction/dynamic stability control system 10, a regenerative braking system 12, an engine start/stop system 14, an electric power steering system 16, and an electric automatic roll control system 17. Other systems 18 may be connected to bus B. Any one or more systems may be connected to bus B to source and/or sink power to/from bus B.

As mentioned above, one or more systems connected to bus B may act as a power source. For example, suspension system 8 may be a regenerative suspension system configured to generate power in response to wheel and/or vehicle movement. Regenerative braking system 12 may be configured to generate power when the vehicle's brakes are applied.

One or more systems connected to bus B may act as a power sink. For example, traction/dynamic stability control system 10 and/or power steering system 16 may be high-power loads. As another example, suspension system 8 may be an active suspension system that has power provided by bus B to power an active suspension actuator.

One or more systems connected to bus B may act as a power source and as a power sink at different times. For example, suspension system 8 may be an active/regenerative suspension system that generates power in response to wheel events and draws power when an active suspension actuator is actively driven.

In some embodiments, vehicle electrical system 1 may have an energy storage apparatus 6. Energy storage apparatus 6 may be coupled to bus B, either directly or indirectly, to provide power to one or more vehicle systems 20 connected to bus B. For example, as shown in FIG. 2, a terminal of energy storage apparatus 6 may be directly connected to bus B (i.e., by a conductive connection such that a terminal of energy storage apparatus 6 is at the same electrical node as bus B). Alternatively or additionally, energy storage apparatus 6 may be indirectly connected to bus B. For example, as shown in FIG. 3, energy storage apparatus 6 may be directly connected to bus A (i.e., by a conductive connection such that a terminal of energy storage apparatus 6 is at the same electrical node as bus A), and indirectly connected to bus B via the power converter 4. As illustrated in FIG. 4, in some embodiments energy storage apparatus 6 may be connected to both bus A and bus B. As shown in FIG. 4, a first terminal of energy storage apparatus 6 may be directly connected to bus B and a second terminal of energy storage apparatus 6 may be directly connected to bus A. However, energy storage apparatus 6 may be connected in any suitable configuration, as the techniques described herein are not limited in this respect.

In some embodiments, energy storage apparatus 6 may provide power to a load coupled to bus B instead of or in addition to power provided by the vehicle battery 2. In some embodiments, energy storage apparatus 6 may supply power in response to a load, thereby reducing the amount of power that needs to be drawn from vehicle battery 2 in response to the load. Providing at least a portion of the power by energy storage apparatus 6 in response to a large load may avoid drawing a large amount of power from the vehicle battery 2. Drawing an excessive amount of power from vehicle battery 2 may cause the voltage of bus A to droop to an unacceptably low voltage or reduce the state of charge of vehicle battery 2. Thus, there is a limit to the amount of power that can be drawn from vehicle battery 2. Providing power from energy storage apparatus 6 in response to the load may enable providing a higher amount of power to a load than would be possible in the absence of energy storage apparatus 6.

Energy storage apparatus 6 may include any suitable apparatus for storing energy, such as a battery, capacitor or supercapacitor, for example. Examples of suitable batteries include a lead acid battery, such as an Absorbent Glass Mat (AGM) battery, and a lithium-ion battery, such as a Lithium-Iron-Phosphate battery. However, any suitable type of battery, capacitor or other energy storage apparatus may be used. In some embodiments, energy storage apparatus 6 may include a plurality of energy storage apparatus (e.g., a plurality of batteries, capacitors and/or supercapacitors). In some embodiments, the energy storage apparatus 6 may include a combination of different types of energy storage apparatus (e.g., a combination of a battery and a supercapacitor). In some embodiments, energy storage apparatus 6 may include an apparatus that can quickly provide a significant amount of power to the at least one system 20 coupled to bus B. For example, in some embodiments, energy storage apparatus 6 may be capable of providing greater than 0.5 kW, greater than 1 kW, or greater than 2 kW of power. In some embodiments, energy storage apparatus 6 may have an energy storage capacity of 1 kJ to several hundred kJ (e.g., 100 to 200 kJ or greater). If energy storage apparatus 6 includes one or more supercapacitor(s), the supercapacitor(s) may have an energy storage capacity of between 1 kJ and 10 kK, or greater than 10 kJ. Supercapacitors are capable of very high peak powers. By way of illustration, a supercapacitor string with 1 kJ of energy storage may provide greater than 1 kW of peak power. If the energy storage apparatus includes one or more batteries, the one or more batteries may have an energy storage capacity of between 10 kJ and 200 kJ, or greater than 200 kJ. In comparison with supercapacitors, a 10 kJ battery string may be limited to about 1 kW of peak power. In some embodiments, energy storage apparatus 6 may achieve both high capacity energy storage with high peak power using battery strings connected in parallel and/or using a combination of batteries and supercapacitors.

In some embodiments, the energy storage apparatus 6 is provided with a battery management system and/or a balancing circuit 9. The battery management system and/or balancing circuit 9 may balance the charge among the batteries and/or supercapacitors of energy storage apparatus 6.

In an exemplary embodiment, suspension system 8 may be an active suspension system for a vehicle that can actively control an active suspension actuator (e.g., to control movement of a wheel). Active control of an active suspension actuator may be performed to anticipate and/or respond to forces exerted by a driving surface on a wheel of the vehicle. The active suspension system may include one or more actuators driven by power supplied from bus B. For example, an actuator may include an electric motor that can drive a fluid pump to actuate a hydraulic damper. An actuator controller may control the actuator in response to motion of the vehicle and/or wheel. For example, an active suspension actuator may raise a wheel in anticipation of or response to a bump to reduce transfer of force to the remainder of the vehicle. As another example, an active suspension actuator may lower a wheel into a pothole to minimize movement of the remainder of the vehicle when the wheel hits the pothole. In some situations, the actuator controller may demand a significant amount of power (e.g., 500 W) be provided quickly from bus B to drive the active suspension actuator. The energy storage apparatus 6 coupled to bus B may provide at least a portion of the power demanded by the actuator.

In some embodiments, the controller 5 and/or power converter 4 may be configured to limit an amount of power provided from bus A (e.g., from vehicle battery 2) to bus B no higher than a maximum power. Setting a maximum power that may be drawn from bus A may prevent drawing an excessive amount of energy from the vehicle battery 2, and avoid causing a voltage drop on bus A, for example. Any suitable value of maximum power may be chosen depending on the vehicle and factors such as the energy storage capacity and/or the state of charge of vehicle battery 2, or other factors, as discussed further below. Controller 5 may control power converter 4 based on the maximum power. Controller 5 may store information representing the maximum power in a suitable data storage apparatus.

When power is demanded by a system connected to bus B, the power may be supplied by vehicle battery 2 (e.g., via bus A and power converter 4), energy storage apparatus 6 or a combination of vehicle battery 2 and energy storage apparatus 6. When the power drawn from bus A is below the maximum power, power converter 4 may allow power to be drawn from bus A. However, the power converter 4 may be controlled to prevent the amount of power drawn from bus A from exceeding the maximum. When the amount of power demanded from bus A exceeds the maximum, power converter 4 may be controlled to limit the amount of power provided to bus B to the maximum power.

As an example, if power converter 4 is configured to limit the power drawn from the vehicle battery 2 to no more than a maximum power of 1 kW, and the amount of power demanded by bus B from vehicle battery 2 is 0.5 kW, the power converter 4 may supply the required 0.5 kW to bus B. However, if more than 1 kW is required, the power converter 4 may provide the maximum power (e.g., 1 kW, in this example) to bus B and the additional power necessary may be drawn from energy storage apparatus 6. For example, if the maximum power that can be drawn from the vehicle battery and supplied to bus B is 1 kW, and a load coupled to bus B demands 2 kW, then 1 kW of power may be provided from the vehicle battery 2 and the remaining 1 kW of power may be provided by the energy storage apparatus 6.

The power converter 4 may limit the power provided from bus A to bus B in any suitable manner. In some embodiments, the power converter 4 may limit the power provided from bus A to bus B by limiting the current drawn from the vehicle battery 2. In some embodiments, the power converter 4 may limit the input current (at the bus A side) of power converter 4. A maximum current and/or power value may be stored in any suitable data storage apparatus coupled to controller 5. In some embodiments, controller 5 may set one or more operating parameters of the power converter 4 (e.g., duty cycle, switching frequency, etc.) to limit the amount of power that flows through power converter 5 to the maximum power.

In some embodiments, the maximum power that can be provided from bus A to bus B may be limited (e.g., by power converter 4) based on the amount of energy and/or the average power transferred from bus A to bus B over a time period. In some embodiments, the amount of energy and/or power provided from bus A to bus B over a period of time may be limited to avoid drawing a significant amount of energy from the vehicle battery 2, which may cause a voltage drop on bus A and/or reduce the state of charge of vehicle battery 2.

FIG. 5 shows an exemplary plot of the maximum power that may be drawn from vehicle battery 2 for various time periods. In the example of FIG. 5, if power is drawn from the vehicle battery 2 for a relatively small period of time (e.g., one second), a relatively high maximum power may be allowed to be transferred from bus A to bus B by power converter 4. However, transferring a significant amount of power for a relatively long period of time may draw a significant amount of energy from the vehicle battery 2, potentially causing a drop in the voltage of bus A. Thus, a lower maximum power may be set when drawing power from the vehicle battery for a longer period of time. The maximum power may be gradually reduced for longer periods of time. For example, after power has been drawn from the vehicle battery 2 for more than one second, the maximum power may be reduced to avoid overly discharging the vehicle battery 2. This may prevent a scenario where the vehicle is idling and the battery becomes fully discharged due to a large amount of power being drawn from bus A to bus B over a significant period of time. The maximum power may be reduced even further if power is drawn from the vehicle battery for longer periods of time (e.g., over 100 seconds). The maximum power may be reduced for such periods of time to maintain vehicle efficiency at an acceptable level. The maximum power may thus change (e.g., be reduced) the longer that current is provided from bus A to bus B. If more power is required from a load coupled to bus B than the maximum power, the additional power necessary to satisfy the load may be provided by energy storage apparatus 6, in some embodiments.

The plot shown in FIG. 5 is one example of a way in which the maximum power and/or energy that can be provided from bus A to bus B may be set by power converter 4 based upon the amount of time for which power is provided from bus A to bus B. Any suitable maximum power and/or energy may be selected based amount of time that power is drawn, and is not limited to the exemplary curve shown in FIG. 5. In some embodiments, the maximum power and/or energy may be set using a mapping such as a curve or a lookup table stored by controller 5.

In some embodiments, the maximum power that may be provided from bus A to bus B may be set based upon the state of the vehicle. The state of the vehicle may be a measure of energy available from bus A. For example, the state of the vehicle may include information regarding the state of charge of vehicle battery 2, engine RPM (e.g., which may indicate if the vehicle is at idle), or the status of one or more loads connected to bus A drawing power from the vehicle battery 2. If the state of charge of the vehicle battery 2 is low, the engine RPM is low, and/or one or more loads connected to bus A are in a state where they are drawing significant power from the vehicle battery 2, the maximum power that may be provided from bus A to bus be may be reduced. As another example, the state of the vehicle may include the status of a dynamic stability control (DSC) system connected to bus A. If the dynamic stability control system is currently operating to stabilize the vehicle, and drawing power via bus A, the maximum power that may be provided from bus A to bus B may be reduced so that sufficient energy is available in the vehicle battery 2 for the dynamic stability control system connected to bus A. As another example, when the vehicle's headlights or air conditioner are turned on, they may draw significant power from the vehicle battery 2. Accordingly, the maximum power that may be provided for bus A to bus B be may be reduced when the headlights and/or air conditioner are turned on to avoid drawing down the vehicle battery 2. The maximum power may be set based upon any suitable state of the vehicle representing the amount of energy available on bus A.

As discussed above, the power converter 4 may limit the power transferred from bus A to bus B based on the maximum power. Information regarding the state of the vehicle and/or the maximum power may be provided to controller 5 by a system coupled to the communication network 7. For example, information regarding the state of the vehicle may be provided by an engine control unit, or any other suitable control system of the vehicle that has information regarding the state of the vehicle.

Typical switching DC/DC converters are designed to convert a DC input voltage into a DC output voltage that is substantially constant. Although a switching DC/DC converter has an output voltage ripple, in general typical switching DC/DC converters are designed to minimize the output voltage ripple to produce as constant a DC output voltage as possible. In a conventional switching DC/DC converter, the output voltage ripple may be a very small fraction (e.g., <1%) of the DC output voltage.

The present inventors have recognized and appreciated that allowing the voltage of bus B to vary from its nominal voltage may enable reducing the amount of energy storage capacity of energy storage apparatus 6. In some embodiments, bus B may be a loosely regulated bus that may have significant voltage swings in response to loads and/or regenerated power on bus B. Instead of attempting to fix the voltage of bus B as close as possible to a nominal voltage (e.g., 48V or 42V), the power converter 4 may be configured to allow the output voltage at bus B to vary within a relatively wide range from the nominal voltage. In some embodiments, the voltage of bus be may be allowed to vary within a range that is greater than 5%, up to 10%, or up to 20% of the nominal voltage of bus B (e.g., the average voltage of bus B or the average of the maximum and minimum voltage thresholds). In some embodiments, the voltage of bus B may be kept between a first threshold and a second threshold (e.g., between minimum and maximum voltage values). As an example, if bus B is nominally a 48 V DC bus, the voltage of bus B may be allowed to vary between 40 V and 50 V, in some embodiments. However, the techniques described herein are not limited as to particular range of voltages that are allowable for voltage bus B.

In some embodiments, the techniques described herein may be applied to an electric vehicle. In an electric vehicle, the vehicle battery 2 may have a relatively high capacity to enable driving a traction motor to propel the vehicle. For example, in some embodiments, the vehicle battery 2 may be a battery pack having a pack voltage of 300-400 V or greater. Accordingly, in an electric vehicle, bus A may be a high voltage bus for driving the traction motor that propels the vehicle, and bus B may be at a lower voltage. Power converter 4 may be a DC/DC converter that converts the high voltage of bus A into a lower voltage at bus B. In some embodiments, bus B may have a nominal voltage of 48 V, as discussed above. However, the techniques described herein are not limited as to the voltage of bus B.

As discussed above, a suspension system 8 may be connected to bus B. In some embodiments, the suspension system 8 of an electric vehicle may be an active suspension system and/or a regenerative suspension system. If the suspension system 8 is configured to operate as an active suspension system, the active suspension system may draw power from vehicle battery 2 via the power converter 4. If the suspension system 8 is configured to operate as a regenerative suspension system, the energy generated by the regenerative suspension system may be stored in energy storage apparatus 6 and/or may be transferred to vehicle battery 2 via power converter 4. The power converter 4 may be bidirectional to allow energy transfer from bus B to bus A, as discussed above.

As discussed above, the loads coupled to bus B can be capable of demanding a significant amount of power. The inventors have recognized and appreciated that it would be desirable to predict future driving conditions to predict the amount of energy that will be needed by a load coupled to bus B. Predicting the energy that will be needed may allow the vehicle electrical system to prepare in advance by making enough energy available to meet the expected load. For example, if it is predicted that a significant amount of power will need to be supplied to a load on bus B in the near future, the vehicle electrical system may prepare in advance by charging energy storage apparatus 6 to increase the amount of energy that is available to meet the demand. Power converter 4 may control the flow of power between bus A and bus B to regulate the state of charge of the energy storage apparatus 6 based upon a predicted future driving condition.

They predicted future driving condition may be determined based on information from a sensor or other device that determines information about the vehicle that is indicative of the future driving condition.

As an example, a forward-looking sensor may be mounted on the vehicle and may sense features of the driving surface such as bumps or potholes. The forward looking sensor may be any suitable type of sensor, such as a sensor that senses and processes information regarding electromagnetic waves (e.g., infrared, visual and/or RADAR waves). Information from the forward-looking sensor may be provided to a controller (e.g., controller 5) that may determine additional energy should be supplied to energy storage apparatus 6 in anticipation of a large load being drawn from the active suspension system when the vehicle is expected to travel over a bump or pothole.

Another example of a device that senses information that may be indicative of future driving conditions is a steering action sensor. A steering action sensor may detect the amount of steering being applied to steer the vehicle. Such information may be provided to a controller (e.g., controller 5) that may determine additional energy should be supplied to energy storage apparatus 6 in anticipation of a load being drawn from the active suspension system to counter the rolling force of an anticipated turning maneuver.

Information indicative of future driving conditions may be provided by any suitable vehicle system. In some embodiments, such information may be provided by a vehicle system that is powered by bus B or bus A.

An example of a device that senses information that may be indicative of future driving conditions is a suspension system. For example, in a vehicle that includes four wheels, the front two wheels may have active suspension actuators that may be displaced in response to a feature of the driving surface, such as a pothole, bump, etc. Such actuators may detect the amount of displacement produced by such an event at the front wheel(s). Information regarding the event may be provided to controller (e.g., controller 5) which may determine that additional energy should be provided to energy storage apparatus 6 in anticipation of a load being drawn from the active suspension system when the rear wheels travel over the same feature of the driving surface.

Information that may be indicative of future driving conditions may be obtained from any suitable system coupled to bus A or bus B, such as an electric power steering system, an antilock braking system, or an electronic stability control system, for example.

Another example of a device that senses information that may be indicative of future driving conditions is a vehicle navigation system. A vehicle navigation system may include a device that determines the position of the vehicle, such as a global positioning system (GPS) receiver. Other relevant types of information may be obtained from a vehicle navigation system, such as the speed of the vehicle. The vehicle navigation system may be programmed with a destination, and may prompt the driver to follow a suitable route to reach the destination. Accordingly, the vehicle navigation system may have information that indicates future driving conditions, such as upcoming curves in the road, traffic, and/or locations at which the vehicle is expected to stop (e.g., intersections, the final destination, etc.). Such information may be provided to a controller (e.g., controller 5) that determines whether additional energy should be provided to energy storage apparatus 6. Controller 5 may control power converter 4 to regulate the state of charge of energy storage apparatus 6 based upon such information. For example, if the navigation system predicts that a turn is upcoming, additional energy may be provided to charge energy storage apparatus 6 in anticipation of a large electrical load from the active suspension system to counter the rolling force of the turn.

As illustrated in FIG. 4, in some embodiments energy storage apparatus 6 may have a first terminal connected to bus A and a second terminal connected to bus B. Connecting energy storage apparatus 6 between bus A and bus B may reduce the voltage across energy storage apparatus 6 as compared with the case where energy storage apparatus 6 is connected between bus B and ground (e.g., the vehicle chassis). Energy storage apparatus 6 may include a plurality of energy storage devices, such as batteries or supercapacitors, that are stacked together in series to withstand the voltage across the energy storage apparatus 6, as each battery cell or supercapacitor may individually only be able to withstand of voltage from less than 2.5V to 4.2V. Reducing the voltage across the energy storage apparatus 6 may reduce the number of batteries or supercapacitors that need to be stacked in series, and thus may reduce the cost of the energy storage apparatus 6.

FIG. 6A illustrates a system in which power converter 4 includes a bidirectional DC/DC converter that can provide power from bus B to bus A to recharge vehicle battery 2 based on power generated by a power source coupled to bus B (e.g., a regenerative suspension system or regenerative braking system). In the example of FIG. 6A, 20 A of current is supplied to the DC/DC converter by bus B. Due to the 4:1 voltage ratio between bus B and bus A, the current on bus B is converted into 80 A of current at bus A to charge the vehicle battery 2.

FIG. 6B shows a system in which energy storage apparatus 6 is connected to bus A and bus B, in parallel with the power converter 4. As illustrated in FIG. 6B, there are two electrical paths for the current to flow from bus B to bus A: through the DC/DC converter; and through the energy storage apparatus 6. The magnitude and direction of power and/or current that flows through the electrical paths between bus B and bus A may be controlled by the power converter 4, which may set the relative impedances of the power converter 4 and/or the energy storage apparatus 6. In the example of FIG. 6B, power converter 4 is operated such that power flows through power converter 4 from bus B to bus A. In this example, 10 A of current flows from bus B into the power converter 4, 10 A of current flows from bus B through energy storage apparatus 6, and 40 A of current flows from the power converter 4 into bus A, thereby providing a total of 50 A of current to charge the vehicle battery 2.

FIG. 6C shows a system as in FIG. 6B, in which the power converter 4 is operated to transfer power in the reverse direction, such that power flows through power converter 4 from bus A to bus B, while charging the vehicle battery 2 with a lower amount of power. In this example, 20 A of current flows from bus A into the power converter 4, and 5 A of current flows out of power converter 4 to bus B. The 20 A of current supplied by bus B and the 5 A of current from the power converter 4 combine such that 25 A of current flows through the energy storage apparatus 6. As a result, 5 A of current is provided to charge the vehicle battery 2. Thus, by controlling the magnitude and/or direction of the power flowing through power converter 4, the effective impedance of energy storage apparatus 6 and/or the amount of power provided to charge/discharge vehicle battery 2 and/or energy storage apparatus 6 may be controlled. Such control may be effected by controller 5 based on any suitable control algorithm based on factors such as the state of the vehicle (e.g., the amount of power available on bus A and/or bus B), future predicted driving conditions, or any other suitable information.

In some embodiments, an electronically controlled cutoff switch 11 may be connected in series with the energy storage apparatus 6 to stop the flow of current therethrough. The electronically controlled cutoff switch may be controlled by controller 5.

As discussed above, energy storage apparatus 6 may include one or more capacitors (e.g., supercapacitors). However, supercapacitors capable of storing a substantial amount of energy while providing a nominal +48V are very large and expensive. To provide a nominal 48V, a capacitor that can handle as much as 60V may be required, increasing the size and cost even further.

Advantages of connecting the supercapacitors across bus A and bus B may include reducing the number of cells in the supercapacitor, which reduces cost and size, and eases the impedance requirements of the capacitor, because the impedance of a supercapacitor may be proportional to the number of series cells. The result is more efficient charging and discharging of the supercapacitor. Inrush current may be avoided using such a topology, as power converter 4 may control the initial charging of the supercapacitors using a controlled current.

In some embodiments, controller 5 may use a multi-level hysteretic control algorithm to control power converter 4. The multi-level hysteretic control described herein maximizes the energy stored in the supercapacitors, minimizes power lost in the power converter 4 by only using it when necessary and keeps the current of the vehicle battery 2 as low as possible. Storing energy in the supercapacitors is more efficient than passing it through the power converter 4 twice to store energy temporarily in the vehicle battery.

The hysteretic control method described herein uses two levels of hysteretic control with quasi-proportional gain above the second level. Being fundamentally hysteretic, it is robust, stable and insensitive to parameter changes like supercapacitor capacitance and equivalent series resistance (ESR), battery voltage, etc.

The hysteretic control method does not require any real-time knowledge of the instantaneous power requirements of the loads on bus B. It can therefore operate standalone without any means of communications with the rest of the system other than via the DC bus voltage. Additional information such as road condition, vehicle speed, alternator setpoint and active suspension setting (e.g. “eco,” “comfort,” “sport”) can be used to adjust the various setpoints of the hysteretic controller for even better efficiency.

FIG. 7 illustrates an embodiment in which multi-level hysteretic current control of the power converter 4 is performed in an embodiment in which energy storage apparatus 6 is connected across bus A and bus B, as shown in FIGS. 4, 6B and 6C. The total current in the vehicle battery 2 is the sum of the current through the power converter 6 plus the current through the energy storage apparatus 6. The graph of FIG. 7 shows the current through the power converter 4 (Iconverter) as a function of the DC bus voltage (Vbus) and the direction of change of the bus voltage. It uses multiple voltage thresholds: Vhh, Vhi, (Vhi-Hysteresis), (Vlo+Hysteresis), Vlo, and Vll as well as two sliding thresholds: Vmax and Vmin to control the current optimally within the limits +Iactive_max and −Iregen_max.

For a majority of the time, the bus voltage remains between Vhh and Vll and the converter current is limited to +Iactive and −Iregen. For example, when the bus voltage rises above Vhi, the converter regenerates Iregen current to the battery and it keeps draining the bus and regenerating until the bus voltage falls below (Vhi−Hysteresis) at which point the converter current goes to zero. It operates similarly when the bus voltage fails below Vlo by pulling Iactive current from the battery.

However, when the Iregen current is already flowing into the battery and the bus voltage continues to rise and goes above Vhh, the converter increases the regenerative current, up to the limit Iregen_max, in direct proportion to (Vbus−Vhh). A similar overload region exists for bus voltages below Vll. In these overload regions, the highest or lowest voltage reached become the sliding setpoint Vmax and Vmin, respectively. The highest current magnitude reached is held until the bus voltage either falls below (Vmax−Hysteresis) or rises above (Vmin+Hysteresis) at which point, the current returns to Iregen or Iactive level, respectively. The converter then returns to normal, non-overload, operation as described above. All of the current set points and voltage thresholds can be adjusted (within bounds) to optimize the applications. Though only one hysteresis is shown in FIG. 7, it is possible to have as many as four different hysteresis values for the four regions: normal-active, normal-regeneration overload-active, and overload-regen.

FIG. 8A-8F show examples of topologies including power converter 4 and energy storage apparatus 6. Any of the topologies described herein, or any other suitable topology, may be used.

FIG. 8A shows the supercapacitor string connected to bus B where the voltage compliance is large but the voltage across the string is also high. Such an embodiment may use a large number of cells (e.g., 20) in series at 2.5V/cell.

FIG. 8B shows the supercapacitor string on bus A in parallel with the vehicle battery 2 where the voltage compliance is defined by the vehicle alternator, battery and loads, and is therefore low, but the voltage across the string is also low. Such an embodiment may use 6 to 7 cells in series but the cells may have much larger capacitance and a lower Effective Series Resistance (ESR) than the embodiment of FIG. 8A.

FIG. 8C shows the supercapacitor string in series with the vehicle battery 2. This topology can have large voltage compliance but generally works in applications where the current in the supercapacitor string averages to zero. Otherwise uncorrected, the supercapacitor string voltage may drift toward zero or overvoltage. Also, the supercapacitors need to handle higher currents than the embodiment of FIG. 8A and the power converter 4 needs to handle the full peak power requirements of bus B.

FIG. 8D shows the supercapacitor string in series with the output of the DC/DC converter. This topology may work in applications in which the current in the supercapacitor string averages to zero.

FIG. 8E shows the supercapacitor string across the DC/DC converter between bus A and bus B. This topology is functionally similar to the topology of FIG. 8A, but it reduces the number of cells needed to meet the voltage requirements from 20 to 16 by referencing the supercapacitor string to bus A rather than chassis ground, reducing the string voltage requirement by at least 10 V (the minimum battery voltage.)

The topology of FIG. 8F solves the average supercapacitor current limitation of the embodiment of FIG. 8D by adding an auxiliary DC/DC converter 81 to ensure that the supercapacitor string current averages to zero even when the DC bus current does not average to zero.

Other combinations of these embodiments, such as adding the auxiliary DC/DC converter 81 to the embodiment of FIG. 8C, are also possible. The best topology for a specific application primarily depends on the cost of supercapacitors as compared to power electronics and on the installation space available. Additionally, alternative energy storage devices than supercapacitors such as batteries may be used in the same or similar configurations as those disclosed here.

FIG. 9A-9F show topologies similar to those of FIGS. 8A-8F, respectively, with batteries substituted in place of supercapacitors.

FIG. 9G shows a topology having dual power converters 4A and 4B. Power converter 4A is connected between bus A and bus B. Power converter 4B is connected in series with an energy storage apparatus 6, between energy storage apparatus 6 and bus B. In some embodiments, power converter 4A and 4B may allow independently controlling the power drawn from energy storage apparatus 6 and vehicle battery 2.

FIG. 9H shows a dual input or “split” converter topology in which the power converter 4 has three terminals: a terminal connected to bus A, a terminal connected to bus B, and a terminal connected to energy storage apparatus 6. The second terminal of energy storage apparatus 6 may be connected to ground.

FIG. 9I shows a split converter topology similar to the embodiment of FIG. 9H in which a third energy storage apparatus (e.g., a supercapacitor) is connected to bus B. The second terminal of the third energy storage apparatus may be connected to ground.

FIG. 9J shows a split converter topology similar to the embodiment of FIG. 9H in which the third energy storage apparatus is connected across bus B and the positive terminal of the energy storage apparatus 6.

One of the advantages of the dual input or “split” converter topology over using two separate converters is the size, cost and complexity savings of only having a single set of converter output components, such as low impedance capacitors. The split converter topology also allows the switching devices in the two input sections to be switched out of phase resulting in lower ripple current handling requirements for the low impedance output capacitors.

FIGS. 9K-9N show various dual converter topologies in which one or more energy storage apparatus in addition to the vehicle battery 2 may be connected in various configurations.

In the embodiments described herein, capacitors may be replaced by batteries, where suitable, and batteries may be replaced by supercapacitors, where suitable.

As discussed above, the voltage of bus B may be allowed to fluctuate in response to loads and/or power generated by systems coupled to bus B. The voltage of bus B may be indicative of the state of the vehicle as it relates to the amount of energy available in an energy storage apparatus 6 coupled to bus B. In some embodiments, control of one or more systems coupled to bus B and/or control of the power converter 4 may be performed based on the voltage of bus B. For example, if the voltage of bus B drops, it may indicate a state of low energy availability in the energy storage apparatus 6. One or more systems coupled to bus B may measure the voltage of bus B, and may determine that the vehicle is in a state of low energy availability on bus B. In response, one or more system(s) coupled to bus B that are not safety-critical may reduce the amount of power that they may draw from bus B. For example, systems such as a power steering system or active suspension system may reduce the amount of power that the can draw from bus B. When the voltage on bus B rises, indicating that the amount of energy available in energy storage apparatus 6 has risen to an acceptable level, such systems may resume drawing power from the bus B at a level typical of a state of normal or high energy availability.

In some embodiments, such a technique may be applied to control of an active suspension system. As discussed above, an active suspension system of a vehicle may be powered by a voltage bus (e.g., bus B) that is controllably isolated from a primary vehicle voltage bus (e.g., bus A) to facilitate mitigating impact on the vehicle systems connected to the primary voltage bus (e.g., bus A) as the suspension system's demand for power can vary substantially based on speed, road conditions, suspension performance goals, and the like. As demand on bus B varies, the voltage level of bus B may also vary, generally with the voltage level increasing when demand is low or in the case of regenerative systems when regeneration levels are high, and voltage decreasing when demand is high. By monitoring the voltage level of bus B, it may be possible to determine, or at least approximate, the state of the vehicle as it relates to the energy available on bus B. The energy available on bus B may be affected by the load and/or regenerated power produced by system(s) coupled to bus B. For example, the energy available on bus B may reflect suspension system conditions. As noted above, a decreased voltage level on bus B may indicate a high demand for power by the suspension system to respond to wheel events. This information may in turn allow a determination, or approximation, of other information about the vehicle; for example, a high demand for power due to wheel events may in turn indicate that the road surface is rough or sharply uneven, that the driver is engaging in driving behavior that tends to result in such wheel events, and the like.

As discussed above, an active suspension system may have an active suspension actuator 22 controlled by a corner controller 28 for each wheel of the vehicle, as illustrated in FIGS. 10A and 10B, FIG. 10A shows a block diagram of active suspension actuator 22 and corner controller 28. Active suspension actuator 22 may be mechanically coupled to the wheel of a vehicle and may dampen wheel movements. Active suspension actuator 22 may actively control wheel movements, drawing power from bus B to drive motor 24 (e.g., optionally a three-phase brushless motor) which actuates pump 26 to displace and/or change the pressure of fluid in a hydraulic damper mechanically connected to the wheel. In response to wheel and/or vehicle movement, active suspension actuator 22 may generate power based on the movement and/or change of pressure of fluid in the damper, thereby actuating pump 26 and allowing motor 24 to produce regenerated power which may be supplied to bus B. Corner controller 28 controls the active suspension actuator 22, and may control the amount of power applied from bus B to the active suspension actuator 22 and/or the amount of power provided from active suspension actuator 22 to bus 13. Corner controller 28 may include a DC/AC inverter 32 that converts the DC voltage at bus B into an AC voltage to drive motor 24. DC/AC inverter 32 may be bidirectional, and may enable providing power from motor 24 to bus B when motor 24 is operated as a generator. In this sense, motor 24 may be an electric machine capable of operating either as a motor or a generator, depending on the manner in which is controlled by corner controller 28.

Corner controller 28 includes a controller 30 that determines how to control the DC/AC inverter 32 and/or the active suspension actuator 22. Controller 30 may receive information from one or more sensors of the active suspension actuator 22, the motor 24 and/or pump 26 regarding an operating, parameter of the active suspension actuator 22. Such information may include information regarding movement of the damper, force on the damper, hydraulic pressure of the damper, motor speed of motor 24, etc. In some embodiments, controller 30 may receive information from a communications bus 34 from another corner controller 28 and/or an optional centralized vehicle dynamics processor (e.g., which may be implemented by controller 5, for example). Communications bus 34 may be the same as or different from communications bus 7 (discussed above in connection with FIG. 1). Controller 30 may measure the voltage of bus B and/or the rate of change of the voltage of bus B to obtain information regarding the state of the vehicle as it relates to the energy available from bus B, Controller 30 may process any or all of such information and determine how to control active suspension actuator 22 and/or DC/AC inverter 32. For example, corner controller 28 may “throttle” power to the active suspension actuator 22 by reducing power and/or a maximum power of the active suspension actuator 22 based upon the voltage of bus B falling below a threshold and/or the rate of change of the voltage on bus B falling below a threshold (e.g., decreasing quickly). When the voltage recovers, corner controller 28 may throttle power to the active suspension actuator 22 by increasing power and/or a maximum power of the active suspension actuator 22 based upon the voltage of bus B rising above a threshold and/or the rate of change of the voltage on bus B rising above a threshold (e.g., increasing quickly enough to signal a recovery).

In some embodiments, bus B may transfer energy among corner controllers 28 and power converter 4, as can be seen in the exemplary system diagram of FIG. 10B. Each corner controller 28 may independently monitor bus B to determine the overall system conditions for taking appropriate action based on these system conditions, as well as monitoring any wheel events being experienced locally for the wheel 25 with which the corner controller 28 is associated. Alternatively or additionally, controller 5 may centrally monitor bus B to determine the overall system conditions and may send commands to one or more corner controllers 28. In this sense, control of active suspension actuators 22 may be distributed (e.g., performed at the corner controllers 28) or centralized (e.g., performed at controller 5), or a combination of distributed control and centralized control may be used.

FIG. 11 shows exemplary operating regions for voltages on bus B, according to some embodiments, which may indicate different operating conditions for the systems connected to bus B (e.g., a corner controller, or a system other than an active suspension system). Exemplary system conditions that may be determined from the voltage of bus B are shown in FIG. 11, which shows the voltage range of bus B divided into operating condition ranges by various thresholds. In some embodiments, a corner controller 28 and/or controller 5 may measure the voltage on bus B and determine an operating condition based upon one or more thresholds.

In the example of FIG. 11, when the voltage of bus B is below the threshold UV the bus may be in an operating condition range associated with an under voltage shutdown operating condition. When the voltage of bus B is between the threshold UV and the threshold V_{Low}, the bus may be in an operating condition range associated with a fault handling and recovery operating condition. When the voltage of bus B is between threshold V_{Low} and the threshold V_{Nom}, the bus may be in an operating condition range associated with a bias low energy operating condition. When the voltage of bus B is between threshold V_{Nom} and V_{High} the bus may be in an operating condition range associated with a net regeneration operating condition. When the voltage of bus B is between the threshold V_{High} and the threshold OV, a bus may be in an operating condition range associated with a load dump operating condition. However, the techniques described herein are not limited to the operating modes and/or ranges shown in FIG. 11, as other suitable operating ranges or conditions may be used.

As illustrated in FIG. 11, normal operating range conditions may include net regeneration and bias low energy. When the voltage level of bus B signals that the system is in a state of net regeneration, a suspension control system coupled to bus B may measure the voltage to determine the state of the bus B, and upon determining that the state is net regeneration, may activate functions such as supplying power to bus A. A bias low energy condition may indicate to an active suspension system that available energy reserves are being taxed, so preliminary measures to conserve energy consumption may be activated. In an example of preliminary energy consumption mitigation measures, wheel event response thresholds may be biased toward reducing energy demand. Alternatively or additionally, when a bias low energy system condition is detected, energy may be requested from bus A by power converter 4 to supplement the power available from the suspension system. A voltage above a normal operating range may indicate a load dump condition. This may be indicative of the suspension system or regenerative braking system regenerating excess energy to such a great degree that it cannot be passed in full or in part to bus A, so that there is a need for at least a portion of the energy to be shunted off. A suspension system controller, such as a corner controller 28 for a vehicle wheel 25, may detect this system condition and respond accordingly to reduce the amount of energy that is regenerated by the controller's active suspension actuator 22. One such response may be to dissipate energy in the windings of an electric motor 24 in the active suspension actuator 22. Operating states that are below the normal operating range may include fault handling and recovery states, and an under-voltage shutdown state. In some embodiments, operation in a fault handling and recovery state may signal to the individual corner controllers 28 to take actions to substantially reduce energy demand. To the extent that each corner controller 28 may be experiencing different wheel events, stored energy states, and voltage conditions, the actions taken by each corner controller 28 may vary, and in embodiments different corner controllers 28 may operate in different operating states at any given time. An under-voltage shutdown condition may be indicative of an unrecoverable condition in the system (e.g. a loss of vehicle power), a fault in one of the independent corner controllers, or a more serious problem with the vehicle (e.g. a wheel has come off) and the like. The under voltage shutdown state may cause the corner controller 28 to control the active suspension actuator 22 to operate solely as a passive or semi-active damper, rather than a fully active system, in some embodiments.

As noted above, the DC voltage level of bus B may define system conditions. It also define the energy capacity of the system. By monitoring the voltage of bus B, each system coupled to bus B, such as corner controller 28 and/or controller 5, can be informed of how much energy is available for responding to wheel events and maneuvers. Using bus B to communicate suspension system and/or vehicle energy system capacity may also provide safety advantages over separated power and communication buses. By using voltage levels of bus B to signify operational conditions and power capacity, each corner controller 28 can operate without concern that a corner controller 28 is missing important commands that are being provided over a separate. communication bus to the other corner controllers. In addition, it may either eliminate the need for a signaling bus (which may include additional wiring), or reduce the communication bus bandwidth requirements.

By providing a common bus B to all, or a plurality of, the corner controllers 28, each corner controller 28 can be safely decoupled from others that may experience a fault. In an example, if a corner controller 28 experiences a fault that causes the power bus voltage level to be substantially reduced, the other corner controllers 28 may sense the reduced power bus voltage as an indication of a problematic system condition and take appropriate measures to avoid safety issues. Likewise, with each corner controller capable of operating independently as well as being tolerant of complete power failure, even under severe power supply malfunction, the corner controllers 28 still take appropriate action to ensure acceptable suspension operation.

As discussed above, a plurality of systems may be coupled to bus B, as shown in FIG. 1. In some embodiments, each system coupled to bus B may be assigned a priority level. A system that relates to vehicle safety (e.g., anti-lock braking system) may be given a high-priority, and less critical systems may be given a lower priority. The systems coupled to bus B may have thresholds that are compared with the voltage of bus B and/or the rate of change of the voltage of bus B for determining a suitable state of operation based on the available energy. A load may reduce the power that it demands from bus B when the voltage falls below a threshold for example. In some embodiments, the systems with a high priority level may have voltage thresholds set lower than that of a lower priority system. Accordingly, the high-priority systems may draw power under conditions of low energy availability, while low-priority systems may not draw power or may draw reduced power during periods of low energy availability, and may wait until the bus voltage recovers to higher level. The use of different priority levels may facilitate making sure energy is available to high-priority systems.

A loosely regulated bus B can facilitate an effective energy storage architecture. Energy storage apparatus 6 may be coupled to bus B, and the bus voltage may define the amount of available energy in energy storage apparatus 6. For example, by reading the voltage level of bus B, each corner controller 28 of an active suspension system may determine the amount of energy stored in energy storage apparatus 6 and can adapt suspension control dynamics based on this knowledge. By way of illustration, for a DC bus that is allowed to fluctuate between 38V and 50V, an energy storage apparatus including a capacitor or supercapacitor with a total storage capacitance C, the amount of available energy (neglecting losses) is:

Energy=½*C*(50)̂2−½*C*(38)̂2=528*C

Using this calculation or similar calculations, the corner controllers 28 are able to adapt algorithms to take into account the limited storage capacity, along with the static current capacity of a central power converter to supply continuous energy.

In some embodiments, the operating thresholds of bus B (e.g., the operating thresholds illustrated in FIG. 11) may be dynamically updated based on the state of the vehicle or other information. For example, during starting of the vehicle, the voltage thresholds may be allowed to go lower.

The terms “passive,” “semi-active” and “active” in relation to a suspension are described as follows. A passive suspension (e.g., a damper) produces damping forces that are in the opposite direction as the velocity of the damper, and cannot produce a force in the same direction as the velocity of the damper. A semi-active suspension actuator may be controlled to change the amount of damping force that is produced. However, as with a passive suspension, a semi-active suspension actuator produces damping forces that are in the opposite direction as the velocity of the damper, and cannot produce a force in the same direction as the velocity of the damper. An active suspension actuator may produce forces on the actuator that are in the same direction or the opposite direction as the velocity of the actuator. In this sense, an active suspension actuator may operate in all four quadrants of a force-velocity plot. A passive or semi-active suspension actuator may operate in only two quadrants of a force-velocity plot for the damper.

The term “vehicle” as used herein refers to any type of moving vehicle such as a 4-wheeled vehicle (e.g., an automobile, truck, sport-utility vehicle etc.) and vehicles with more or less than four wheels (including motorcycles, light trucks, vans, commercial trucks, cargo trailers, trains, boats, multi-wheeled and tracked military vehicles, and other moving vehicles). The techniques described herein may be applied to electric vehicles, hybrid vehicles, combustion-driven vehicles, or any other suitable type of vehicle.

The embodiments described herein may be beneficially combined with vehicle architectures such as hybrid electric vehicles, plugin hybrid electric vehicles, battery powered electric vehicles. Suitable loads may also include drive by wire systems, brake force amplification, brake assist and boost, electric AC compressors, blowers, hydraulic fuel water and vacuum pumps, start/stop functions, roll stabilization, audio system, electric radiator fan, window defroster, and active steering systems.

In some embodiments the main electrical source for the vehicle (such as a vehicle alternator) may be electrically connected to bus B. In such an embodiment, the power converter (e.g., DC/DC converter) may be disposed to convert energy from bus B to bus A, however in some cases a bidirectional converter may be desirable. In such an embodiment, the alternator charging algorithm or control system may be configured to allow for voltage bus fluctuations in order to utilize voltage bus signaling, energy storage capability, and other features of the system. In some cases the alternator may be connected to bus B and provide additional energy during braking events, such as on a mild hybrid vehicle. Alternator controllers and ancillary controllable loads may be used to prevent transient overvoltage conditions on bus B if the load on the bus suddenly drops when the alternator is in a high current output state.

In many embodiments the bus A and bus B may share a common ground. However, in some embodiments the power converter (e.g., DC/DC converter) may galvanically isolate bus B from bus A. Such a system may be accomplished with a transformer-based DC/DC converter. In some cases digital communication may be isolated as well, such as through optoisolators.

### Additional Aspects

In some embodiments, techniques described herein may be carried out using one or more computing devices. Embodiments are not limited to operating with any particular type of computing device.

FIG. 12 is a block diagram of an illustrative computing device 1000 that may be used to implement a controller (e.g., controller 5 and/or 30) as described herein. Alternatively or additionally, a controller may be implemented by analog or digital circuitry.

Computing device 1000 may include one or more processors 1001 and one or more tangible, non-transitory computer-readable storage media (e.g., memory 1003). Memory 1003 may store, in a tangible non-transitory computer-recordable medium, computer program instructions that, when executed, implement any of the above-described functionality. Processor(s) 1001 may be coupled to memory 1003 and may execute such computer program instructions to cause the functionality to be realized and performed.

Computing device 1000 may also include a network input/output (I/O) interface 1005 via which the computing device may communicate with other computing devices (e.g., over a network), and may also include one or more user I/O interfaces 1007, via which the computing device may provide output to and receive input from a user.

The above-described embodiments can be implemented in any of numerous ways. For example, the embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-discussed functions of one or more embodiments. The computer-readable medium may be transportable such that the program stored thereon can be loaded onto any computing device to implement aspects of the techniques discussed herein. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An electrical system for a vehicle, comprising:
a power converter configured to convert a vehicle battery voltage at a first electrical bus into a second voltage at a second electrical bus, the second voltage being at least as high as the vehicle battery voltage; and
an energy storage apparatus coupled to the second electrical bus;
wherein at least one load is coupled to the second electrical bus, and
wherein the power converter is configured to provide power from the first electrical bus to the at least one load and to limit a power drawn from the first electrical bus to no higher than a maximum power, and wherein, when the at least one load draws more power than the maximum power, the at least one load at least partially draws power from the energy storage apparatus.

2. The electrical system of claim 1, wherein the power converter comprises a DC/DC converter.

3. The electrical system of claim 1, when the at least one load draws less power than the maximum power, the power drawn by the at least one load is supplied by both the power converter and the energy storage apparatus.

4. The electrical system of claim 1, wherein the power converter is configured to limit the power drawn from the first electrical bus by limiting a current drawn from the first electrical bus to no more than a maximum current.

5. The electrical system of claim 4, wherein the maximum current limit comprises at least one time averaged current value.

6. The electrical system of claim 1, wherein a terminal of the energy storage apparatus is at a same electrical node as the second electrical bus.

7. The electrical system of claim 1, wherein the energy storage apparatus is coupled to the second electrical bus via the power converter.

8. The electrical system of claim 1, further comprising at least one of a battery management system and a balancing circuit configured to control the energy storage apparatus.

9. The electrical system of claim 1, wherein the maximum power is controlled by an electronic controller and sent to the power converter by the electronic controller.

10. An electrical system for a vehicle, comprising:
a power converter configured to convert a vehicle battery voltage at a first electrical bus into a second voltage at a second electrical bus, the second voltage being at least as high as the vehicle battery voltage,
wherein the power converter is configured to provide power from the first electrical bus to a load coupled to the second electrical bus, and to limit a power drawn from the first electrical bus to no higher than a maximum power based on an amount of energy drawn from the first electrical bus over a time interval.

11. The electrical system of claim 10, wherein the power is a first power, the maximum power is a first maximum power, the amount of energy is a first amount of energy, and the time interval is a first time interval, and
wherein the power converter is configured to limit a second power drawn from the first electrical bus to no higher than a second maximum power based on a second amount of energy drawn from the first electrical bus over a second time interval.

12. The electrical system of claim 10, wherein the power converter comprises a DC/DC converter.

13. The electrical system of claim 10, when the at least one load draws less power than the maximum power, the power drawn by the at least one load is supplied by both the first electrical bus and an energy storage apparatus coupled to the second electrical bus.

14. The electrical system of claim 10, wherein the power converter is configured to limit the power drawn from the first electrical bus by limiting a current drawn from the first electrical bus to no more than a maximum current.

15. The electrical system of claim 10, wherein the maximum power is controlled by a controller coupled to the power converter via a communications network.

16. An electrical system for a vehicle, comprising:
a power converter configured to convert a vehicle battery voltage at a first electrical bus into a second voltage at a second electrical bus, the second voltage being at least as high as the vehicle battery voltage, the power converter being configured to receive a signal indicating a state of the vehicle,
wherein the state of the vehicle represents a measure of energy available from the first electrical bus,
wherein at least one load is coupled to the second electrical bus, and
wherein the power converter is configured to provide power from the first electrical bus to the at least one load and to limit a power drawn from the first electrical bus based on the state of the vehicle.

17. The electrical system of claim 16, wherein the power converter comprises a DC/DC converter.

18. The electrical system of claim 16, wherein the power converter is configured to limit the power drawn from the first electrical bus by limiting a current drawn from the first electrical bus to no more than a maximum current.

19. The electrical system of claim 18, wherein the maximum current comprises at least one time averaged current value.

20. The electrical system of claim 16, wherein the power converter is configured to limit the power drawn from the first electrical bus by limiting a power drawn from the first electrical bus to no more than a maximum power, wherein the maximum power is controlled by a controller coupled to the power converter.

21. An electrical system for a vehicle, comprising:
a power converter configured to convert a vehicle battery voltage at a first electrical bus into a second voltage at a second electrical bus, wherein the power converter is configured to allow the second voltage to vary in response to a power source and/or power sink coupled to the second electrical bus, and wherein the second voltage is allowed to fluctuate between a first threshold and a second threshold.

22. The electrical system of claim 21, wherein the power converter comprises a DC/DC converter.

23. The electrical system of claim 21, wherein the power source and/or power sink comprises a regenerative power source.

24. The electrical system of claim 23, wherein the power source and/or power sink comprises a regenerative braking system and/or a regenerative suspension system.

25. The electrical system of claim 21, wherein the second voltage is at least as high as the vehicle battery voltage.

26. The electrical system of claim 21, wherein a difference between the first threshold and the second threshold is at least 5% of an average of the first threshold and the second threshold.

27. The electrical system of claim 26, wherein the difference between the first threshold and the second threshold is at least 10% of the average of the first threshold and the second threshold.

28. The electrical system of claim 27, wherein the difference between the first threshold and the second threshold is at least 20% of the average of the first threshold and the second threshold.

29. The electrical system of claim 21, wherein the second voltage is controlled by both the power converter and at least one load controller operatively coupled to the second electrical bus controlling at least one load,
wherein the at least one load controller measures the second voltage,
wherein the at least one load controller comprises a motor controller, and
wherein the at least one load controller runs an algorithm that controls the load based on the second voltage.

30. The electrical system of claim 21, wherein the first threshold comprises a low voltage limit, and the second threshold comprises a high voltage limit.

31. The electrical system of claim 21, wherein the first electrical bus operates at substantially 12 V, and the second electrical bus operates substantially between 40 and 50V.

32. The electrical system of claim 21, wherein a controller that controls the power converter and/or a load coupled to the second electrical bus determines the second voltage and determines an operating state of the vehicle based on the second voltage, the operating state comprising a at least one of a load dump state, a second electrical bus to first electrical bus regenerative state, a first electrical bus to second electrical bus consumption state, a overvoltage protection state, a short circuit state, an energy storage recharge state, an energy storage discharge state, wherein the operating state is determined based on comparing the second voltage to one or more voltage thresholds delineating the operating state, and wherein the controller controls the power converter and/or a load coupled to the second electrical bus based upon the operating state.

33. The electrical system of claim 32, wherein the one or more voltage thresholds are dynamically updated based upon a vehicle state representing an amount of energy available via the first electrical bus and/or the second electrical bus.

34. An electrical system for an electric vehicle, comprising:
a first electrical bus that operates at a first voltage and drives a drive motor of the electric vehicle;
an energy storage apparatus coupled to the first electrical bus;
a second electrical bus that operates at a second voltage lower than the first voltage;
a power converter configured to transfer power between the first electrical bus and the second electrical bus; and
at least one electrical load connected to and controlled by an electronic controller, the at least one electrical load being powered from the second electrical bus, wherein the at least one electrical load comprises an active suspension actuator.

35. The electrical system of claim 34, wherein the power converter comprises a DC/DC converter.

36. The electrical system of claim 34, wherein the power converter is bidirectional or unidirectional.

37. The electrical system of claim 34, wherein the electronic controller comprises a four-quadrant controller, wherein the active suspension actuator is actively controlled or semi-actively controlled.

38. An electrical system for a vehicle, comprising:
an electrical bus configured to deliver power to a plurality of connected loads;
an energy storage apparatus coupled to the electrical bus, wherein the energy storage apparatus has a state of charge, and wherein the energy storage apparatus is configured to deliver power to the plurality of connected loads;
a power converter configured to provide power to the energy storage apparatus and regulate the state of charge of the energy storage apparatus; and
at least one device that obtains information regarding an expected future driving condition,
wherein the power converter regulates the state of charge of the energy storage apparatus based on the expected future driving condition.

39. The electrical system of claim 38, wherein the at least one device that obtains information regarding an expected future driving condition comprises at least one of:
a forward-looking sensor;
a steering action sensor;
a vehicle navigation system;
an active suspension system actuator;
a receiver identifying a position of the vehicle; and
a load of the plurality of connected loads.

40. The electrical system of claim 39, wherein the at least one device that obtains information regarding an expected future driving condition comprises a first front active suspension actuator and a second front active suspension actuator.

41. The electrical system of claim 38, wherein the plurality connected loads comprises at least one integrated active vehicle suspension system mechanically coupled to one or more wheels of the vehicle.

42. The electrical system of claim 41, wherein the plurality of connected loads comprises a second system that controls vehicle motion.

43. The electrical system of claim 42, wherein the second system comprises at least one of an electric power steering system, an anti-lock braking system, an electric anti-roll stability system, and an electronic stability control system.

44. The electrical system of claim 38, wherein a terminal of the energy storage apparatus is at a same electrical node as the second electrical bus.

45. The electrical system of claim 38, wherein the energy storage apparatus is coupled to the second electrical bus via the power converter.

46. An electrical system for a vehicle, comprising:
a power converter configured to convert a vehicle battery voltage at a first electrical bus into a second voltage at a second electrical bus, the second voltage being at least as high as the vehicle battery voltage; and
an energy storage apparatus connected across the power converter, wherein a first terminal of the energy storage apparatus is connected to the first electrical bus and a second terminal of the energy storage apparatus is connected to the second electrical bus;
wherein at least one load is coupled to the second electrical bus, and
wherein the power converter is configured to provide power from the first electrical bus to the at least one load and to limit a net power drawn from the first electrical bus to no higher than a maximum power, wherein net power drawn from the first electrical bus comprises a combination of power through the power converter and the energy storage apparatus.

47. The electrical system of claim 46, wherein the power converter comprises a DC/DC converter.

48. The electrical system of claim 46, wherein at least one of the at least one load is configured to regenerate power to the second electrical bus.

49. The electrical system of claim 46, wherein the energy storage apparatus comprises at least one of a capacitor, a super capacitor, a lead acid battery, a lithium-ion battery, and a lithium-phosphate battery.

50. The electrical system of claim 46, wherein the power converter is configured to control a magnitude and/or direction of power flow through the power converter to control net power flow into or out of the first electrical bus.

51. The electrical system of claim 50, wherein the power converter is configured to operate such that a first current flows through the power converter in a first direction between the first electrical bus and the second electrical bus and a second current flows through the energy storage apparatus in a second direction between the first electrical bus and the second electrical bus, wherein the first and second directions are opposite directions.

52. The electrical system of claim 46, further comprising an electronically controlled cutoff switch connected in series with the energy storage apparatus.

53. The electrical system of claim 46, wherein the second voltage is loosely regulated and allowed to fluctuate between a first threshold and a second threshold.

54. The electrical system of claim 46, wherein the power converter comprises a DC/DC converter that operates as a current source and the second voltage fluctuates in response to a changing load on the second electrical bus.

55. The electrical system of claim 46, wherein the power converter comprises a dual input converter or a plurality of power converters.

56. The electrical system of claim 46, wherein the power converter dynamically regulates current to reduce an effect on the first electrical bus of regenerative power spikes from the second electrical bus.
